(19) United States
(12) Patent Application Publication
(10) Pub. No.: US 2026/0062133 A1
(43) Pub. Date: Mar. 5, 2026

(54) BLENDED WING AIRCRAFT

(71) Applicant: General Electric Company, Cincinnati, OH (US)

(72) Inventors: Arthur William Sibbach, Boxford, MA (US); Randy M. Vondrell, Newport, KY (US); Donald G. Thompson, Swampscott, MA (US); Christopher Francis Poranski, Somerville, OH (US); Erich Alois Krammer, West Chester, OH (US); Jeffrey Douglas Rambo, Mason, OH (US); Brandon Wayne Miller, Middletown, OH (US)

(21) Appl. No.: 18/824,082

(22) Filed: Sep. 4, 2024

(51) Int. Cl. B64D 33/00; B64C 39/10; B64D 29/00; B64F 5/40

(52) U.S. Cl. CPC B64D 33/00; B64C 39/10; B64F 5/40; B64C 2039/105

(57) ABSTRACT

A blended wing aircraft is provided, including: an aircraft engine comprising a lubrication system; a body having a fuselage and a pair of wings extending outward from the fuselage; and an access panel assembly operable with the lubrication system of the aircraft engine, the access panel assembly positioned on or within the body at a location remote from the aircraft engine.

### FIELD

The present disclosure relates to a blended wing aircraft.

### BACKGROUND

Traditional aircraft designs include a fuselage and a pair of wings. The fuselage is a central body of the aircraft that holds passengers, cargo, equipment, and the like. The wings are attached to the fuselage and are the primary lift-generating surfaces, particularly during constant-altitude flight operations. The aircraft can include engines mounted to the wings to generate thrust for the aircraft, and a tail assembly having a vertical stabilizer and a horizontal stabilizer for vector control. While such an aircraft design is a well-established and proven design, improvements to allow for increased efficiency and cargo utilization would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a perspective view of an aircraft in accordance with an exemplary aspect of the present disclosure.

FIG. 2 is a schematic view of an aircraft engine of the aircraft of FIG. 1 in accordance with an exemplary aspect of the present disclosure.

FIG. 3 is a schematic view of a lubrication system of the exemplary aircraft engine of FIG. 2 and an access panel assembly in accordance with an exemplary aspect of the present disclosure.

FIG. 4 is a schematic view of the access panel assembly of FIG. 3 and aspects of the lubrication system of FIG. 3.

FIG. 5 is a schematic view of an access panel assembly in accordance with an exemplary aspect of the present disclosure installed in a body of the aircraft.

FIG. 6 is a flow diagram of a method of performing a maintenance operation on an aircraft engine using an access panel assembly located remotely from the aircraft engine in accordance with an exemplary aspect of the present disclosure.

FIG. 7 is a flow diagram of a method of performing a maintenance operation on an aircraft engine using an access panel assembly located remotely from the aircraft engine in accordance with an exemplary aspect of the present disclosure.

FIG. 8 is a flow diagram of a method of performing a maintenance operation on an aircraft engine using an access panel assembly located remotely from the aircraft engine in accordance with an exemplary aspect of the present disclosure.

FIG. 9 is a flow diagram of a method of performing a maintenance operation on an aircraft engine using an access panel assembly located remotely from the aircraft engine in accordance with an exemplary aspect of the present disclosure.

FIG. 10 is a schematic view of a bottom side of an aircraft in accordance with an exemplary aspect of the present disclosure.

FIG. 11 is a schematic view of an aircraft having an access panel assembly in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “forward” and “aft” refer to relative positions within a gas turbine engine or vehicle, and are based on a normal operational attitude of the gas turbine engine or vehicle. More particularly, forward and aft are used herein are with reference to a direction of travel and a direction of propulsive thrust of the gas turbine engine or vehicle.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

As noted above, improvements to traditional aircraft design to allow for increased efficiency and cargo utilization would be welcomed in the art. The inventors of the present disclosure found that utilization of a blended wing aircraft design can provide such an improvement. In particular, with the blended wing aircraft design, a body of the aircraft can contribute to lift, while also allowing for increased cargo space, improved aerodynamic efficiency, etc.

With the blended wing aircraft design, engines of the aircraft can be mounted on a top side of the body, allowing for the body to block at least a portion of the noise from the engines from impacting community locations, among other benefits. Notably, however, with such a mounting configuration it can be more difficult for maintenance operations on the engines to be performed in between flight operations. For example, various maintenance operations are typically performed on a lubrication system of each engine in between flight operations. It may not be desirable to have maintenance personnel traversing a top side of the blended wing aircraft to perform such maintenance operations.

The present disclosure provides for a system for allowing one or more of these maintenance operations to be performed from a remote location, allowing for the one or more maintenance operations to be performed by maintenance personnel without traversing a top side of the blended wing aircraft. In particular, the present disclosure provides for a blended wing aircraft having an aircraft engine, the aircraft engine includes a lubrication system. The blended wing aircraft further includes an access panel assembly operable with the lubrication system of an aircraft engine, the access panel assembly positioned on or within the body at a location remote from the aircraft engine. In certain exemplary aspects, the access panel assembly may be positioned on a bottom side of the blended wing aircraft. In certain exemplary aspects, the access panel assembly may be positioned on an empennage, underneath one of the pair of wings, in a cargo bay of the body, or in a landing gear bay of the body.

The access panel assembly may allow a maintenance personnel to, e.g., check lubrication levels in a lubrication tank, drain one or more aspects of the lubrication system, fill one or more aspects of the lubrication system, flush a filter of the lubrication system, and more from the remote location despite the engine being located on a top side of the blended wing aircraft.

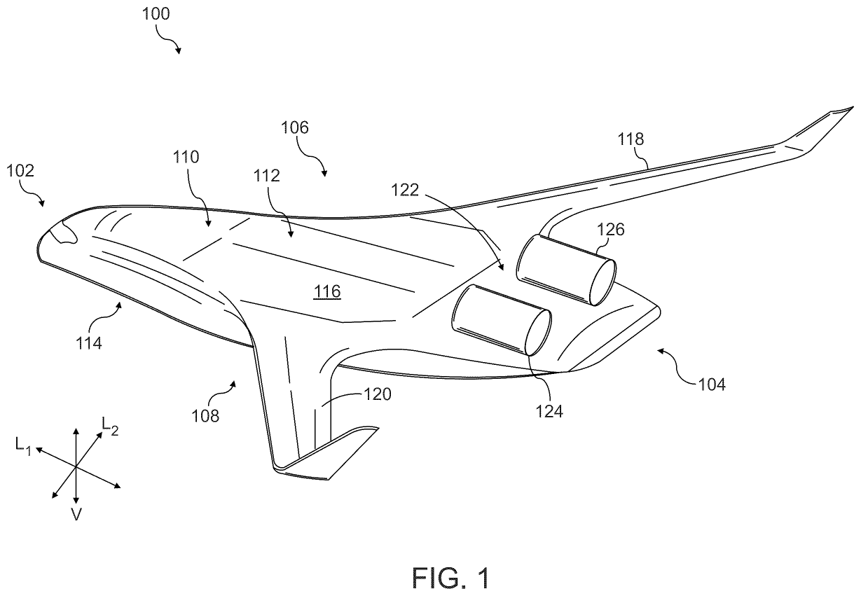

Referring now to the drawings, wherein identical numerals indicate the same elements throughout the figures, FIG. 1 provides a perspective view of an aircraft 100 as may incorporate various embodiments of the present disclosure. In particular, as will be discussed in greater detail, below, the aircraft 100 of FIG. 1 is configured as a blended wing aircraft.

The aircraft 100 defines a longitudinal direction L1 that extends therethrough, a lateral direction L2, a vertical direction V, a forward end 102 and an opposing aft end 16 along the longitudinal direction L1, a starboard side 106 and an opposing port side 108 along the lateral direction L2, and a top side 112 and an opposing bottom side 114 along the vertical direction V.

Further, it will be appreciated that the aircraft 100 includes a body 110 extending longitudinally from the forward end 102 of the aircraft 100 to the aft end 104 of the aircraft 100, and a pair of wings. In particular, the aircraft 100 includes a first wing 118 and a second wing 120. The first wing 118 extends outwardly from the body 110 generally along the lateral direction L2 on the starboard side 106 and the second wing 120 similarly extends outwardly from the body 110 generally along the lateral direction L2 on the port side 108. Although not depicted, it will be appreciated that each of the wings 118, 120 may include one or more leading edge flaps, one or more trailing edge flaps, or both.

The exemplary aircraft 100 of FIG. 1 also includes a propulsion system 122. The exemplary propulsion system 122 depicted includes a plurality of engines, and more specifically includes a first engine 124 and a second engine 126. In the embodiment depicted, the first engine 124 and the second engine 126 are spaced from one another along the lateral direction L2, and are mounted to the body 110 of the aircraft 100 at the aft end 104 of the aircraft 100. It will be appreciated, that as used herein, the term “at the aft end 104” refers to a location along the longitudinal direction L1 closer to the aft end 104 of the aircraft 100 than the forward end 102 of the aircraft 100. Briefly, it will further be appreciated that for the embodiment depicted, the first engine 124 and second engine 126 are mounted to the body 110 of the aircraft 100 on the top side 112 of the aircraft 100.

It will be appreciated, however, that in other exemplary embodiments, the first engine 124 and second engine 126 may be mounted to the body 110, e.g., on a bottom side 114 or at a trailing edge (not labeled). Further, the although the first engine 124 and second engine 126 are coupled to the body 110 in the embodiment shown, in other embodiments, they may be formed integrally with the body 110.

As noted above, the aircraft 100 is configured as a blended wing aircraft. In such a manner, it will be appreciated that the body 110 of the aircraft 100 is generally shaped like an airfoil, such that the body 110 of the aircraft 100 generates upward lift (along the vertical direction V) during steady altitude flight operations. For example, during a cruise operating condition of the aircraft 100, the body 110 may contribute between 10% and 95% of the upward lift for the aircraft 100, such as between 25% and 90% of the upward lift for the aircraft 100, with the remainder being provided by the first and second wings 118, 120. In addition, the first and second wings 118, 120 are aerodynamically contoured to have a smooth transition with the body 110 of the aircraft 100, which can reduce an overall drag on the aircraft 100.

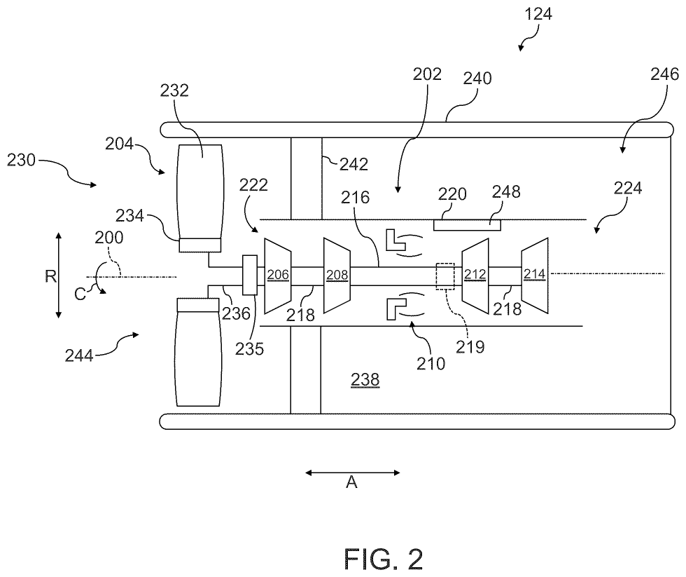

Referring now to FIG. 2, a schematic cross-sectional view of the first engine 124 of the propulsion system 122 of the aircraft 100 of FIG. 1 is presented.

It will be appreciated that although the first engine 124 is depicted and discussed, the second engine 126 may be configured in a similar manner as one or more of these embodiments.

The first engine 124 is configured as a gas turbine engine. For example, the first engine 124 includes a turbomachine 202 and a fan assembly 204, and defines an axial direction A, a radial direction R, and a circumferential direction C. The fan assembly 204 includes a fan 230 positioned proximate a forward end of the first engine 124.

The turbomachine 202 of the gas turbine engine defines a turbomachine inlet 222 and a turbomachine exhaust 224, and includes a compressor section, a combustion section 210, and a turbine section. The compressor section includes a low-pressure compressor 206 and a high-pressure compressor 208. The combustion section 210 receives compressed air from the compressor section and mixes it with fuel for combustion, generating high-energy exhaust gases. These exhaust gases then flow into the turbine section, which includes a high-pressure turbine 212 and a low-pressure turbine 214. The high-energy exhaust gases expand through the turbine section, causing the turbines to rotate and produce mechanical work. In particular, it will be appreciated that for the embodiment shown, the turbomachine 202 further includes a high pressure shaft 216 extending between and mechanically coupling the high-pressure compressor 208 and high pressure turbine 212, and a low pressure shaft 218 extending between and mechanically coupling the low pressure compressor 206 and low pressure turbine 214.

Although not depicted, it will be appreciated that the high pressure shaft 216 and low pressure shaft 218 are supported by a plurality of bearings relative to one or more stationary structures of the turbomachine 202. As is depicted schematically, the turbomachine 202 includes one or more sumps 219 to contain a lubrication provided to the plurality of bearings. The one or more sumps 219 may be positioned at various locations throughout the turbomachine 202.

As noted, the fan assembly 204 includes the fan 230 and defines a fan inlet 244. The fan 230 in turn includes a plurality of fan blades 232 and a fan disk 234, with the plurality of fan blades 232 coupled to the fan disk 234. The fan assembly 204 further includes a fan shaft 236 mechanically coupling the turbomachine 202 with the fan 230 via, e.g., one or more of the low pressure compressor 206 or low pressure shaft 218. In particular, for the embodiment depicted, the first engine 124 further includes a reduction gearbox 235, with the fan shaft 236 being driven by the low pressure shaft 218 across the reduction gearbox 235. The power gearbox 235 is configured to reduce a rotational speed of the fan 230 relative to the low pressure compressor 206.

The first engine 124 further includes a nacelle 240 that encloses the fan 230 and defines in part the fan inlet 244, and further defines an engine exhaust 246 for the embodiment shown. The nacelle 240 surrounds the fan 230 and is coupled to the turbomachine 202 through a plurality of inlet guide vanes 242 located upstream of the fan blades 232 of the fan 230. In such a manner, it will be appreciated that the gas turbine engine of FIG. 2 is, more specifically, configured as a turbofan engine.

Moreover, the nacelle 240 surrounds the turbomachine 202 and defines a bypass passage 238 with an outer casing 220 of the turbomachine 202.

As is also depicted schematically, the first engine 124 further includes a lubrication system 248. The lubrication system 248 can be configured to provide lubrication to various parts of the first engine 124, such as the reduction gearbox 235 and the one or more sumps 219 to lubricate and cool various components.

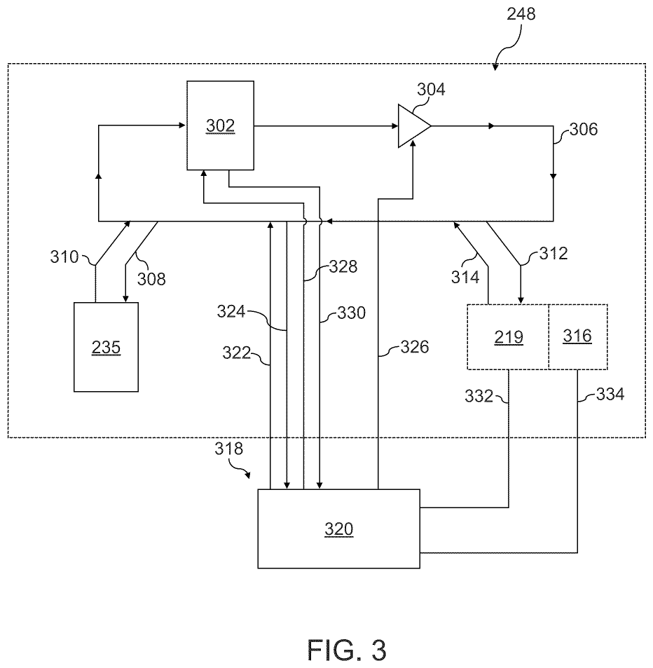

Referring now to FIG. 3, a schematic view of a lubrication system 248 of an exemplary aircraft engine 124 (which may be a first engine 124, referred to simply as “aircraft engine” for simplicity) and an access panel assembly 318 in accordance with an exemplary aspect of the present disclosure is depicted.

The exemplary lubrication system 248 depicted includes a lubrication tank 302, which serves as a reservoir for a lubrication oil of the lubrication system 248, a lubrication pump 304, and a lubrication bus 306. The lubrication pump 304 is operatively connected to the lubrication tank 302 and functions to circulate lubrication oil throughout the system, and in particular, through the lubrication bus 306. The lubrication bus 306 serves as a conduit through which the lubrication oil is distributed to and/or from the lubrication tank 302 to and/or from various engine components requiring lubrication.

The exemplary aircraft engine may generally include a reduction gearbox 235 and an engine sump 219 (see FIG. 2). The lubrication system 248 includes a lubrication supply line 308 and a lubrication scavenge line 310 extending to and from the reduction gearbox 235 to provide a continuous flow of lubrication oil during operation to lubricate and cool the reduction gearbox 235. Similarly, the lubrication system 248 includes a lubrication supply line 312 and a lubrication scavenge line 314 for the engine sump 219, which collects and stores lubrication oil within the engine provided, e.g., to one or more bearings within the engine. These lines allows form lubrication oil to be provided to various moving parts of the first engine 124, maintaining their efficient operation and preventing excessive wear and overheating.

In at least certain exemplary embodiments, the above aspects of the lubrication system 248 may be positioned within the aircraft engine or adjacent to the aircraft engine. Being positioned within the aircraft engine refers to a mounting location within a casing of the engine (such as an outer nacelle 240 or an outer casing 220 of the turbomachine 202; see FIG. 2). Being positioned adjacent to the aircraft engine refers to a mounting location for the component closer to a top side of the aircraft (when the aircraft engine is located on the top side of the aircraft) than a bottom side of the aircraft at a given longitudinal position for the component.

The access panel assembly 318, which can be located on the underside of an aircraft including the first engine 124, includes an access panel 320 that facilitates the maintenance of the lubrication system 248 from a location remote from the aircraft engine 124. This feature is particularly advantageous in blended wing body (BWB) aircraft where the engines may be mounted above the fuselage, making routine maintenance challenging. The access panel 320 allows maintenance personnel to perform various servicing tasks such as filling the lubrication system, draining the oil system, and checking diagnostic indicators without the need to access the engines directly.

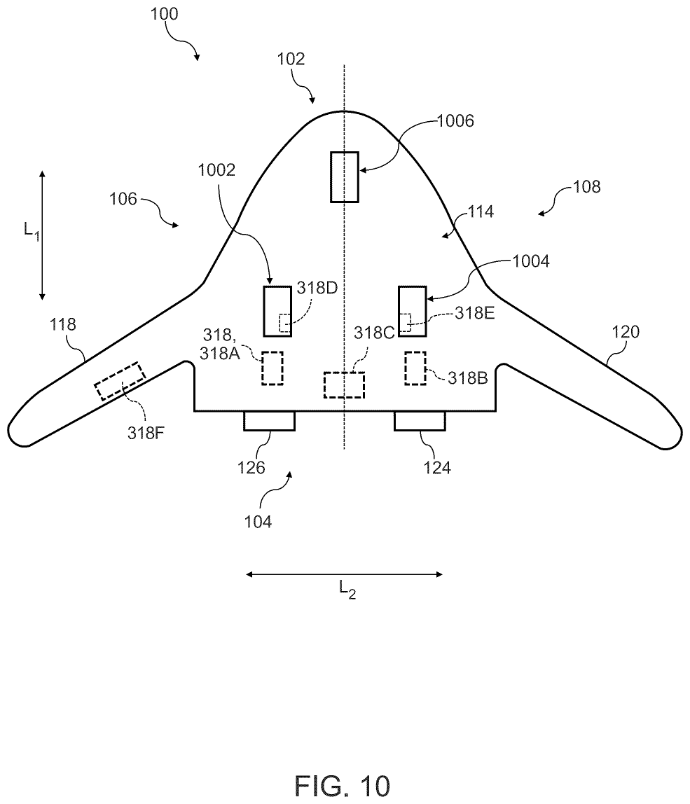

In such a manner, it will be appreciated that as used herein, the term “remote” when describing a location of a first component, e.g., the access panel 320, relative to a second component, e.g., the aircraft engine 124, refers all of the first component being positioned at a location spaced from all of the second component. For example, with respect to the access panel 320 and aircraft engine 124, all of the access panel 320 is spaced from all of the aircraft engine 124 (e.g., not coupled to or positioned within an outermost casing of the aircraft engine 124). In particular, in certain embodiments, the aircraft engine 124 may be located on a top side of the aircraft (e.g., receives an airflow over the top side of the aircraft as its main airflow supply) and the access panel 320 may be located on a bottom side of the aircraft (see also, FIG. 10).

The access panel assembly 318 is connected to the lubrication bus 306 via a supply lubrication line 322 and a return lubrication line 324, allowing for the circulation of lubrication oil between the access panel assembly 318 and the lubrication system 248. The access panel 320 is further connected to the lubrication pump 304 via a power line 326, which may allow for the supply of power (electrical or mechanical) from the access panel assembly 318 to the lubrication pump 304, enabling operation of various maintenance tasks.

Moreover, the access panel assembly 318 is connected to the lubrication bus 306 via a tank supply line 328 and a tank drain line 330, which may facilitate a filling and draining of the lubrication tank 302 from the access panel assembly 318.

Further, still, the access panel assembly 318 is connected to the engine sump 219 via a pressurized gas line 332. Notably, the first engine 124 further includes an engine cavity 316 adjacent to the engine sump 219. The access panel 318 is connected to the engine cavity 316 via a pressurized gas line 334. The pressurized gas lines 332 and 334 extend from the access panel assembly 318 to the engine sump 219 and engine cavity 316, respectively, enabling the application of pressurized gas to these areas.

The present disclosure thus provides a solution to the challenges of servicing the lubrication systems of engines in BWB aircraft. By allowing maintenance operations to be performed remotely from the engines via an access panel located on an underside of the aircraft, the present disclosure enhances the ease and safety of routine maintenance, reducing the need for direct engine access and minimizing the risk of damage to the aircraft.

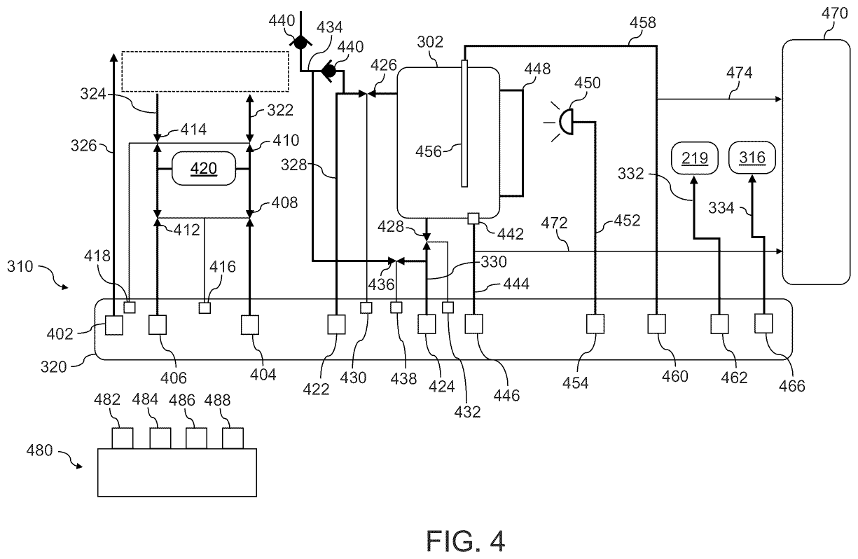

Referring now to FIG. 4, a schematic view of an access panel assembly 318 and aspects of a lubrication system 248 of an aircraft engine in accordance with an exemplary aspect of the present disclosure is provided. The access panel assembly 318 and lubrication system 248 may be configured in a similar manner as one or more of the exemplary access panel assemblies 318 and lubrication systems 248 described hereinabove.

FIG. 4 provides a detailed illustration of various connections, valves, and fluid connection lines that enable the access panel assembly 318 to perform maintenance operations from a remote location relative to the aircraft engine (see FIG. 3). The access panel assembly 318, as part of the present disclosure, can be positioned on an underside of the aircraft, such as within a wheel well, or in a cargo area, allowing for convenient access by maintenance personnel despite a top-mount engine configuration (see FIG. 1).

The access panel assembly 318 includes an access panel 320 that provides connections to both a supply lubrication line 322 and a return lubrication line 324. The supply lubrication line 322 and return lubrication line 324 extend between the access panel 320 and a lubrication bus 306 of the lubrication system 248. The supply lubrication line 322 and return lubrication line 324 enable circulation and maintenance of the lubrication oil within the lubrication system 248.

A power line 326 is provided, which extends from the access panel assembly 318 to a lubrication pump 304 of the lubrication system 248 (see FIG. 3). The power line 326 is configured to supply power to the lubrication pump 304 to enable its operation during maintenance activities. The power may be electrical power, such that the power line 326 is an electrical power line.

Alternatively, the power may be mechanical power, such that the power line 326 is a mechanical connection.

A tank supply line 328 and a tank drain line 330 are also provided. The tank supply line 328 and tank drain line 330 each extend between (and are in fluid communication with) the access panel 320 and a lubrication tank 302 of the lubrication system 248. The tank supply line 328 and tank drain line 330 are designed to facilitate the filling and draining of the lubrication tank 302 from the remote access location. As will be appreciated, the lubrication tank 302 may be located on the engine (e.g., within a casing of the engine). This arrangement may simplify the maintenance process by allowing these tasks to be performed without direct access to the engine.

In the schematic of FIG. 4, the pressurized gas lines 332 and 334 are shown extending from the access panel assembly 318 to the engine sump 219 and the engine cavity 316, respectively.

The access panel assembly 318, and in particular the access panel 320 of the access panel assembly 318, includes a variety of connections and interfaces allowing for maintenance personnel to interact with the lubrication system 248 from the location remote from the first engine 124.

For example, the access panel 320 includes a power connection 402, which may allow for a desired power to be supplied to the lubrication pump 304 via the power line 326.

The access panel 320 further includes a supply lubrication line connection 404 and a return lubrication line connection 406 designed to facilitate the connection of external lubrication servicing equipment 480 to the access panel assembly 318 (discussed in more detail, below), allowing for a variety of maintenance operations. The aircraft 100 includes a first panel side valve 408 and a first engine side valve 410 positioned in the supply lubrication line 322 and a second panel side valve 412 and a second engine side valve 414 positioned in the return lubrication line 324. It will be appreciated, that as used herein, the term “positioned in” refers to the valve being in fluid communication with the respective fluid line to control a mass flow of a fluid therethrough.

In such a manner, it will be appreciated that the first panel side valve 408 and the first engine side valve 410 regulate the flow of lubrication oil into lubrication system 248 (e.g., a lubrication bus 306) and the second panel side valve 412 and the second engine side valve 414 regulate the return flow of lubrication oil from lubrication system 248/lubrication bus 306 (see FIG. 3).

The access panel 320 includes one or more valve control(s) for precise manipulation of these valves. In particular, the access panel includes a valve control 416 operable with the first and second panel side valves 408 and 412 to control the first and second panel side valves 408 and 412, as well as a valve control 418 operable with the first and second engine side valves 410 and 414 to control the first and second engine side valves 410 and 414. These controls 416, 418 allow maintenance personnel to remotely open or close these valves 408, 410, 412, 414 as required during maintenance operations, directly from the access panel 320 of the access panel assembly 318.

As will also be appreciated, the lubrication system 248 further includes an lubrication filter 420, which can assist with maintaining a purity and effectiveness of the lubrication oil. The lubrication filter 420 is positioned within a connection line between the supply lubrication line 322 and the return lubrication line 324. During operation of the lubrication system, lubrication oil from, e.g., the lubrication bus 306 can be directed through the lubrication filter 420 (e.g., through the supply lubrication line 322, the connection line, and the return lubrication line 324) to, e.g., remove contaminants that could cause wear or damage.

The access panel 320 further includes a tank supply line connection 422 fluidly coupled with the tank supply line 328 and a tank drain line connection 424 fluidly coupled with the tank drain line 330. Notably, the aircraft 100 further includes a supply valve 426 positioned in the tank supply line 328 and a drain valve 428 positioned in the tank drain line 330. The access panel 320 further includes a supply valve control 430 operable with the supply valve 426, and a drain valve control 432 operable with the drain valve 428. The supply valve control 430 and drain valve control 432 may allow for control of lubrication oil through the tank supply line 328 and tank drain line 330, respectively, at the access panel 320.

The aircraft 100 further includes a vent line 434 a vent line valve 436 positioned therein, and the access panel 320 further includes a corresponding vent line valve control 438, which allows for the venting of lubrication oil and/or gases from the tank supply line 328, the tank drain line 330, or both during various operations. In such a manner, the vent line 434 is fluidly connected to the tank supply line 328 and the tank train line 330 in the embodiment shown. One or more check valve(s) 440 are incorporated into the vent line 434 to prevent backflow and ensure that gases are only released in the intended direction.

The lubrication system 248 further includes a chip detection sensor 442, which may monitor the presence of metallic debris in the lubrication oil tank 302 and the lubrication oil therein. Such debris can be indicative of wear or damage within the engine and/or usability of the lubrication oil. This sensor is connected via a chip detection connection line 444 to a chip detection interface 446 of the access panel 320, allowing for remote monitoring and analysis of the sensor data.

Additionally, the lubrication tank 302 is equipped with a sight glass 448, which allows for visual inspection of the oil level and condition. The aircraft 100 includes an optical sensing assembly operable with the sight glass 448 to sense data indicative of the sight glass 448. In particular, the optical sensing assembly includes an optical sensor 450 (e.g., a camera) and an optical sensor connection line 452. Further, the access panel 320 includes an optical sensor interface 454. The optical sensor interface 454 is operable with the optical sensor 450 via the optical sensor connection line 452 to provide sensor data to, e.g., maintenance personnel. Such an arrangement may allow visual inspection of the lubrication oil levels from the remote position. In some embodiments, the optical sensor 450 may be in wireless communication with the optical sensor interface 454.

In some embodiments, the access panel assembly 318 and/or the aircraft may additional or alternatively include a borescope to provide the remove viewing of the sight glass 448.

The lubrication system 248 further includes a tank volume sensor 456 operable to sense data indicative of a volume of lubrication oil in the lubrication tank 302. The aircraft 100 further includes a tank volume sensor connection line 458 and the access panel 320 includes a tank volume sensor interface 460. The tank volume sensor 456 is in communication with the tank volume sensor interface 460 via the tank volume sensor connection line 458 in the embodiment depicted.

Pressurized gas connections are also included, with a first pressurized gas connection 462 and a second pressurized gas connection 466, connected to the engine sump 219 and the engine cavity 316, respectively, via pressurized gas lines 332 and 334, respectively. These connections allow for the controlled pressurization of these areas, facilitating maintenance operations that require pressure adjustments and a delta pressure across one or more seals in the engine sump 219 (i.e., between an interior of the engine sump 219 and the engine cavity 316).

Further, the aircraft 100, the first engine 124, or both includes an engine control system 470. The engine control system 470 is connected to the chip detection sensor 442 via a first data connection line 472 and to the tank volume sensor 456 via a second data connection line 474. The engine control system 470 may additionally or alternatively be coupled to various other aspects of the access panel assembly 318, the first engine 124, the aircraft 100, or combinations thereof.

The lubrication servicing equipment 480, which can be connected to the access panel assembly 318 during maintenance operations, includes various connections such as a power connection 482, a lubrication supply connection 484, a lubrication return connection 486, and a pressurized gas source connection 488. These connections may interface with one or more of the connections of the access panel 320 to allow for the transfer of power, lubrication oil, pressurized gas, or the like to or from the access panel 320 during maintenance operations. For example, the power connection 482 can interface with the power connection 402 of the access panel 320 to transfer electrical or mechanical power to the power connection 402 (and power line 326). The lubrication supply connection 484 can interface with the supply lubrication line connection 404, the tank supply line connection 424, or both to provide lubrication oil through the respective connections to the supply lubrication line 322, the tank supply line 328, or both, respectively. The lubrication return connection 486 can interface with the return lubrication line connection 406, the tank drain line connection 424, or both to provide lubrication oil through the respective connections to the lubrication return connection 486.

In summary, the access panel assembly 318 may allow for comprehensive maintenance operations for the first engine's lubrication system from the location remote from the first engine. This system not only enhances the efficiency of maintenance operations but also significantly improves safety by minimizing the need for direct physical access to the engine components in, e.g., a blended wing aircraft with the engine(s) mounted on a top side of the blended wing aircraft.

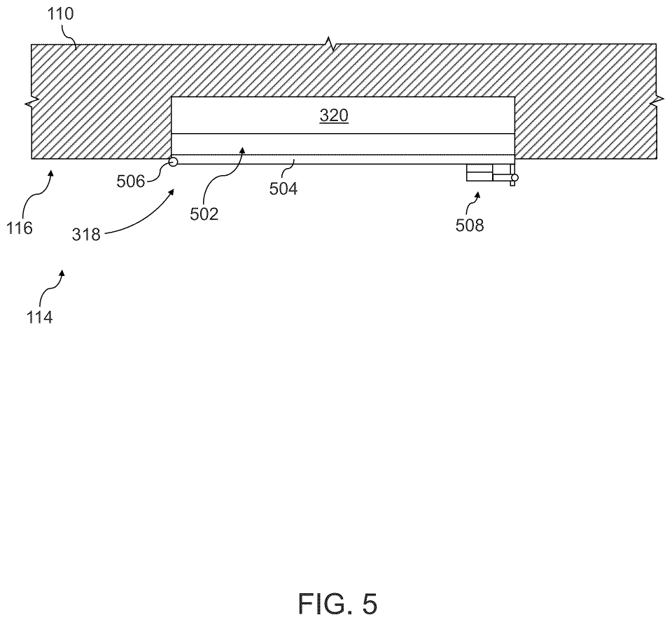

Referring now to FIG. 5, a schematic view of an access panel assembly 318 in accordance with an exemplary aspect of the present disclosure is illustrated. The access panel assembly 318 can be configured in a similar manner as one or more of the access panel assemblies 318 described hereinabove. The access panel assembly 318 is depicted as installed in a body 110 of an aircraft. The body 110 defines a flowpath surface 116 and a bottom side 114 (see, also, flowpath surface 116 and bottom side 114 in FIG. 1).

The access panel assembly 318 includes an access panel 320, that facilitates the interaction with an aircraft engine's lubrication system from a location remote from the engine. The access panel 320 provides an accessible point through which maintenance operations can be conducted without direct access to the aircraft engine, which can be located above the fuselage in a Blended Wing Body (BWB) aircraft configuration (see FIG. 1).

In the embodiment depicted, the body 110 defines a cavity 502, with the access panel 320 positioned within the cavity 502. The cavity 502 is of a sufficient depth to accommodate the necessary connections, valves, and interfaces of the access panel 320.

The access panel assembly 318 includes a door 504 and a hinge 506, with the door 504 coupled to the body 110 at least in part using the hinge. 506. Through the hinge 506, the door 504 is operable to cover or uncover the access panel 320. The door 504 can be moved between an open position, which allows access to the components within the cavity 502 (not shown), and a closed position, which secures the contents and maintains the aerodynamic profile of the aircraft (depicted in FIG. 5).

Furthermore, the access panel assembly 318 includes a coupling, which serves to secure the door 504 to the body 110 of the aircraft. In the embodiment depicted, the coupling is a quick release coupling 508, that may be engaged and disengaged without use of a tool. The quick release coupling 508 can therefore allow for relatively easy engagement and disengagement of the door 504, facilitating access when required and ensuring a secure closure when the door 504 is not in use. This feature is particularly advantageous in situations where time-sensitive maintenance tasks need to be performed, as it can reduce downtime and increase operational efficiency.

The present disclosure, as depicted in FIG. 5, provides a view of the access panel assembly 318 and certain of its components, highlighting the design that allows for remote servicing of the aircraft's lubrication system. The inclusion of a movable door 504 with a hinge 506 and quick release coupling 508 exemplifies the practical and user-friendly approach taken in the design of the access panel assembly 318, ensuring that maintenance personnel can perform their tasks with ease and convenience.

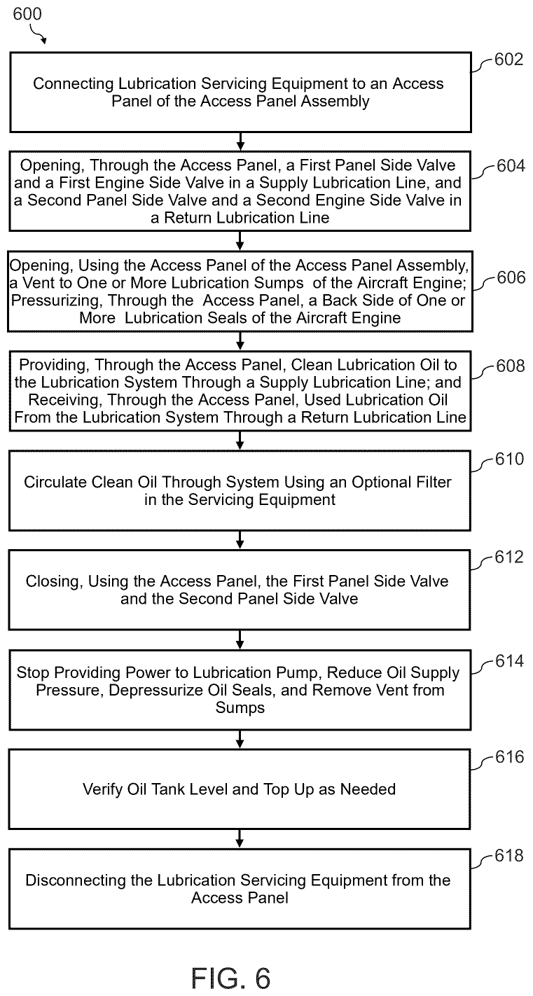

It will be appreciated from the description herein, that in certain exemplary aspects, an access panel assembly in accordance with one or more of the embodiments described herein can be used to perform one or more maintenance operations on a lubrication system of an aircraft engine. In such a manner, it will be appreciated that certain aspects of the present disclosure provide for a method of operating a blended wing aircraft, the method including providing fluid flow to, through, or from a lubrication system of an aircraft engine of the blended wing aircraft using an access panel assembly operable with the lubrication system and positioned on or within a body of the blended wing aircraft at a location remote from the aircraft engine, and modifying the fluid flow using the access panel. In particular, providing fluid flow to, through, or from a lubrication system includes conducting a maintenance operation of the lubrication system of the aircraft engine of the blended wing aircraft using an access panel assembly operable with the lubrication system and positioned on or within a body of the blended wing aircraft at a location remote from the aircraft engine. This method may more specifically include one or more of the exemplary aspects described hereinbelow with reference to FIGS. 6 through 9.

Referring now specifically to FIG. 6, a flow diagram is provided that illustrates a method 600 of conducting a maintenance operation of a lubrication system of an aircraft engine of the blended wing aircraft using an access panel assembly located remotely from the aircraft engine in accordance with an exemplary aspect of the present disclosure. The method 600 may allow for the servicing of the lubrication system of the aircraft engine from a location that is remote from the aircraft engine, enhancing the efficiency and safety of maintenance operations. In particular, it will be appreciated that for the method 600 of FIG. 6, the maintenance operation is a lubrication system flush operation, whereby used lubrication oil within the lubrication system is drained and replaced with new and/or filtered lubrication oil. The method 600 may be utilized with one or more of the exemplary aircraft and access panel assemblies described herein.

The method 600 includes at step 602, connecting lubrication servicing equipment to an access panel of the access panel assembly. This step allows maintenance personnel to interface with the lubrication system of the aircraft engine through the access panel assembly without the need to physically access the engine itself, which is particularly advantageous for engines located on the top side of a blended wing aircraft.

At step 604, the method 600 includes opening, through the access panel, a first panel side valve and a first engine side valve in a supply lubrication line, and a second panel side valve and a second engine side valve in a return lubrication line. This step facilitates the flow of lubrication oil into and out of the lubrication system of the aircraft engine, enabling essential maintenance tasks such as oil changes or system flushes to be carried out.

At step 606, the method 600 includes opening, using the access panel of the access panel assembly, a vent to one or more lubrication sumps of the aircraft engine (see, e.g., engine sump 219 of FIGS. 1, 3, and 4), and pressurizing, through the access panel, a back side of one or more lubrication seals of the aircraft engine (e.g., pressurizing an engine cavity located adjacent to the engine sump, such as engine cavity 316 of FIGS. 3, 4). This action may allow for any used lubrication oil within the lubrication sump to be extracted through a scavenge line and that the seals to be properly pressurized for maintenance.

At step 608, the method 600 includes providing clean lubrication oil to the lubrication system through a supply lubrication line, and receiving used lubrication oil from the lubrication system through a return lubrication line, both actions being performed through the access panel. The clean lubrication oil may be provided to a supply lubrication line connection on the access panel from a lubrication supply connection of lubrication servicing equipment, and the used lubrication oil may be received through a return lubrication line connection and provided to a lubrication return connection of lubrication servicing equipment. This step may allow for replenishing the engine's lubrication system with fresh oil while removing the old oil, maintaining the engine's performance and longevity.

At step 610, the method 600 includes circulating clean oil through the system using an optional filter in the lubrication servicing equipment. This step can remove contaminates and the like from the used lubrication oil before it is provided back to the lubrication system as clean lubrication oil. In at least certain exemplary embodiments, circulating the clean lubrication oil through the system includes providing, through the access panel, power to a lubrication pump of the lubrication assembly.

After providing the clean lubrication oil to the lubrication system at and receiving the used lubrication oil at step 608, the method 600 includes at 612 closing, using the access panel, the first panel side valve and the second panel side valve. This action effectively seals the lubrication system after the maintenance operation has been completed.

In step 614, the method stops providing power to the lubrication pump, reduces oil supply pressure, depressurizes the oil seals (e.g., an engine cavity adjacent to the respective sump having the oil seals), and removes any vents from the sumps. This step concludes the lubrication system flush operation.

Referring still to FIG. 6, the method 600 further includes at step 616 verifying the oil tank level and topping up as needed. This step ensures that the engine's lubrication system contains the correct amount of oil for efficient and safe operation.

Finally, step 618 concludes the method 600 by disconnecting the lubrication servicing equipment from the access panel. This step signifies the completion of the maintenance operation, allowing the aircraft to be prepared for subsequent flight operations.

The method 600, as depicted in FIG. 6, provides a structured approach to performing essential maintenance operations on the aircraft engine's lubrication system from a remote location, leveraging the capabilities of the access panel assembly. This method enhances the overall maintenance workflow, ensuring that such operations can be conducted with minimal disruption to the aircraft's operation and without compromising the safety of maintenance personnel.

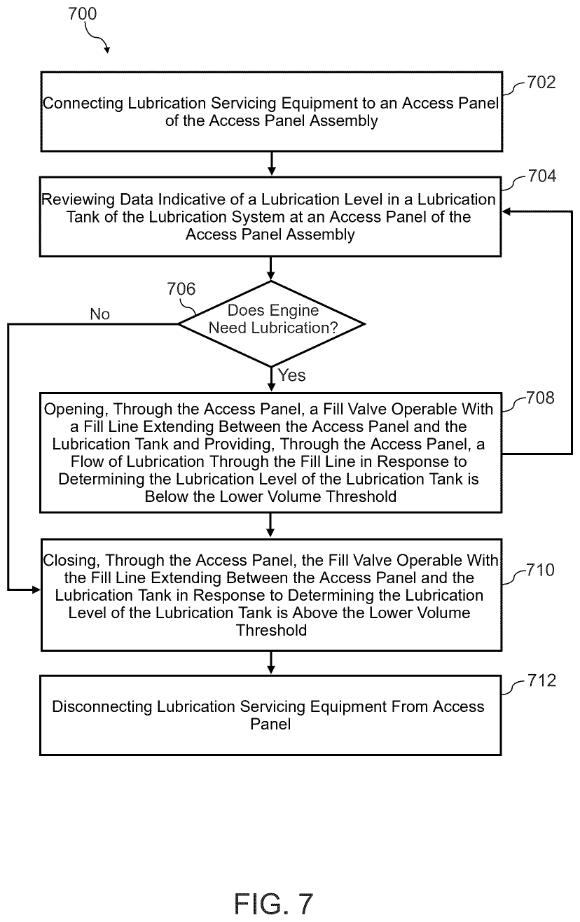

Referring now to FIG. 7, a flow diagram is provided that illustrates a method of conducting a maintenance operation of a lubrication system of an aircraft engine of a blended wing aircraft using an access panel assembly located remotely from the aircraft engine in accordance with an exemplary aspect of the present disclosure. In particular, the flow diagram of FIG. 7 illustrates a method 700 of performing a lubrication system fill operation on the lubrication system of the aircraft engine using the access panel assembly located remotely from the aircraft engine in accordance with an exemplary aspect of the present disclosure. The method 700 is one of the various maintenance operations that can be performed utilizing the access panel assembly of the present disclosure, which provides a remote servicing capability for the lubrication system of the aircraft engine. The method 700 may be utilized with one or more of the exemplary aircraft and access panel assemblies described herein.

The method 700 begins at step 702. At 702, the method 700 includes connecting lubrication servicing equipment to an access panel of the access panel assembly. The lubrication servicing equipment may be configured in a similar manner as lubrication servicing equipment 480 in FIG. 4.

At step 704, the method 700 includes reviewing data indicative of a lubrication level in a lubrication tank of the lubrication system at an access panel of the access panel assembly. This data can be provided, for example, by a tank volume sensor interface operable with a lubrication level sensor within the lubrication system. The review of this data may allow maintenance personnel to assess whether additional lubrication is required for the engine.

Decision step 706 follows, where it is determined whether the engine needs lubrication. The determination at 706 is made based on the reviewed data and, e.g., operational requirements of the engine's lubrication system. If the lubrication level is below a predetermined lower volume threshold, the method proceeds to step 708; otherwise, it skips to step 710.

In step 708, the method 700 includes opening, through the access panel, a fill valve operable with a fill line extending between the access panel and the lubrication tank, and providing, through the access panel, a flow of lubrication through the fill line in response to determining the lubrication level of the lubrication tank is below the lower volume threshold. This step may allow for the lubrication tank to be filled to an appropriate level to maintain operational efficiency and longevity of the engine.

At step 710, once the lubrication level reaches the desired threshold, the method 700 includes closing the fill valve through the access panel. This action may prevent overfilling of the lubrication tank, which may introduce excessive lubrication into the system.

At step 712, the method 700 includes disconnecting the lubrication servicing equipment from the access panel.

The method 700 provides a systematic and efficient approach to conducting a lubrication system fill operation using the access panel assembly of the present disclosure. The steps outlined in the method may allow the lubrication system of the aircraft engine to be maintained at a desired level from a location remote from the engine, enhancing the overall maintenance process and ensuring the reliability and performance of the aircraft engine.

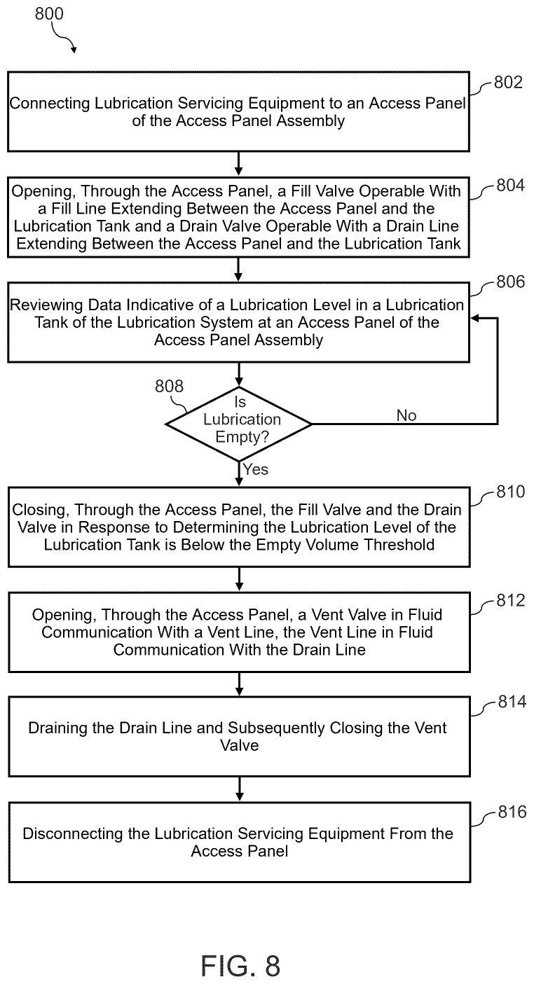

Referring now to FIG. 8, a flow diagram is provided that illustrates a method of conducting a maintenance operation of a lubrication system of an aircraft engine of a blended wing aircraft using an access panel assembly located remotely from the aircraft engine in accordance with an exemplary aspect of the present disclosure. In particular, FIG. 8 provides a flow diagram of a method 800 of performing lubrication system drain operation on the lubrication system of the aircraft engine using the access panel assembly located remotely from the aircraft engine in accordance with an exemplary aspect of the present disclosure is illustrated. This process allows maintenance personnel to perform the necessary tasks from a location remote from the aircraft engine, enhancing safety and efficiency. The method 800 may be utilized with one or more of the exemplary aircraft and access panel assemblies described herein.

At step 802, the method 800 includes connecting the lubrication servicing equipment to an access panel of the access panel assembly. The lubrication servicing equipment may be configured in a similar manner as lubrication servicing equipment 480 in FIG. 4.

At step 804, the method 800 includes opening, through the access panel, a fill valve operable with a fill line extending between the access panel and the lubrication tank, and a drain valve operable with a drain line extending between the access panel and the lubrication tank. This step may allow for the flow of lubrication to be controlled during the draining process.

At step 806, the method 800 includes reviewing data indicative of a lubrication level in a lubrication tank of the lubrication system at the access panel of the access panel assembly. This data review may be conducted by maintenance personnel, a controller operable with the service equipment, a controller of the access panel assembly, an engine controller of the aircraft engine, an aircraft controller, or a combination thereof.

At step 808, the method 800 includes a decision step, where it is determined if the lubrication tank is empty (e.g., below an empty volume threshold). If the lubrication level is below the empty volume threshold, the method advances to step 810; otherwise, the method skips to step 812.

At step 810, the method 800 includes closing, through the access panel, the fill valve and the drain valve in response to determining the lubrication level of the lubrication tank is below the empty volume threshold. This step may confirm that at least a desired amount of lubrication oil has been drained from the tank.

At step 812, the method 800 further includes opening, through the access panel, a vent valve in fluid communication with a vent line, the vent line in fluid communication with the drain line. This action allows air to enter the system to facilitate the complete draining of the lubrication oil.

At step 814, the method 800 includes draining the drain line and subsequently closing the vent valve. This step may allow for all the lubrication oil to be removed from the system and the vent line sealed after the operation.

Additionally, at step 816, the method 800 includes disconnecting the lubrication servicing equipment from the access panel. This disconnection signifies the completion of the lubrication system drain operation, allowing the aircraft to be prepared for further maintenance operations or readiness for flight.

The method 800 depicted in FIG. 8 provides a structured approach for draining the lubrication system of an aircraft engine from a remote location. By utilizing the access panel assembly of the present disclosure, maintenance personnel can perform this operation efficiently and safely, without the need for direct access to the engine. This method exemplifies the practical application of the present disclosure in enhancing the maintenance procedures for aircraft engines, particularly in the context of blended wing aircraft where engine accessibility may be challenging.

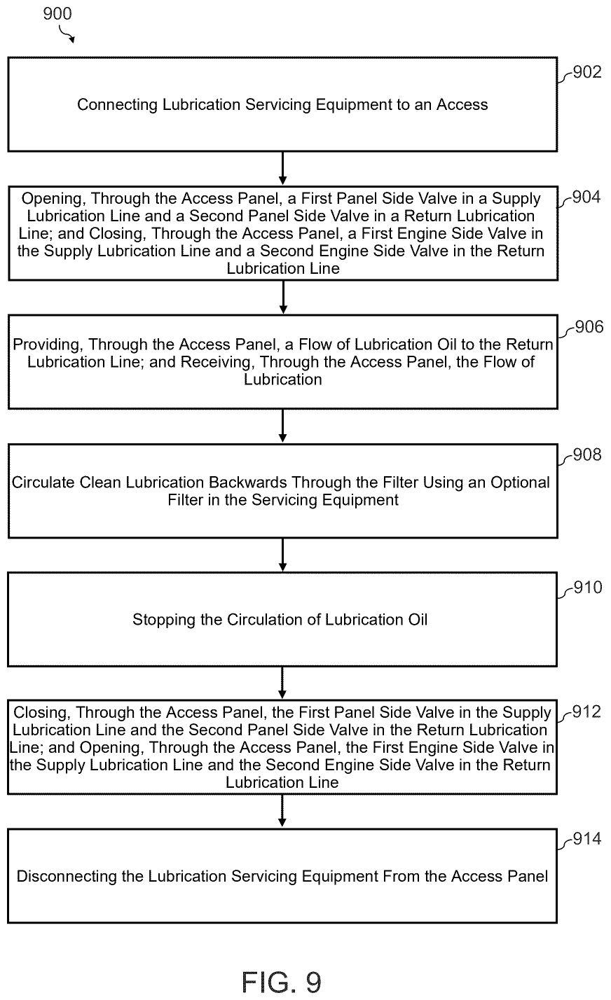

Referring now to FIG. 9, a flow diagram is provided that illustrates a method of conducting a maintenance operation of a lubrication system of an aircraft engine of a blended wing aircraft using an access panel assembly located remotely from the aircraft engine in accordance with an exemplary aspect of the present disclosure. In particular, a flow diagram of a method 900 of performing a lubrication filter backflush operation on the lubrication system of the aircraft engine using the access panel assembly located remotely from the aircraft engine in accordance with an exemplary aspect of the present disclosure is presented. The method 900 outlines a systematic approach for conducting the lubrication filter backflush operation, which may increase an integrity and performance of the aircraft engine's lubrication system. The method 900 may be utilized with one or more of the exemplary aircraft and access panel assemblies described herein.

At step 902, the method 900 includes connecting the lubrication servicing equipment to an access panel of the access panel assembly. The lubrication servicing equipment may be configured in a similar manner as lubrication servicing equipment 480 in FIG. 4.

At step 904, the method 900 includes opening, through the access panel, a first panel side valve in a supply lubrication line and a second panel side valve in a return lubrication line; and closing, through the access panel, a first engine side valve in the supply lubrication line and a second engine side valve in the return lubrication line. This configuration allows for the lubrication filter to be isolated from the remainder of the lubrication system, allowing for the subsequent operations discussed herein.

At step 906, the method 900 includes providing, through the access panel, a flow of lubrication oil to the return lubrication line; and receiving, through the access panel, the flow of lubrication from the supply lubrication line. This step may facilitate the backflush process by directing clean lubrication oil through the filter in the reverse direction, cleansing the filter media.

At step 908, the method 900 includes circulating clean lubrication backwards through the filter using an optional filter in the lubrication servicing equipment. This additional filtration step can further enhance the purity of the lubrication oil and the effectiveness of the backflush operation.

At step 910, the method 900 includes stopping the circulation of lubrication oil circulation.

At step 912, the method 900 includes closing, through the access panel, the first panel side valve in the supply lubrication line and the second panel side valve in the return lubrication line; and, e.g., simultaneously, opening, through the access panel, the first engine side valve in the supply lubrication line and the second engine side valve in the return lubrication line. This action restores the lubrication system to its standard operational flow configuration following the backflush procedure.

At step 914, the method 900 includes disconnecting the lubrication servicing equipment from the access panel. This disconnection signifies the completion of the lubrication system drain operation, allowing the aircraft to be prepared for further maintenance operations or readiness for flight.

The method 900, as depicted in FIG. 9, provides a detailed sequence of steps for performing a lubrication filter backflush operation using the access panel assembly of the present disclosure. This method exemplifies the practical application of the present disclosure in facilitating maintenance operations from a remote location, enhancing the efficiency and safety of the maintenance processes for aircraft engines, particularly in blended wing aircraft configurations where engine accessibility may be challenging.

Referring now to FIG. 10, a schematic view of a bottom side 114 of an aircraft 100 in accordance with an exemplary aspect of the present disclosure is illustrated. The aircraft 100 defines a longitudinal direction L1 and a lateral direction L2, with a forward end 102 and an opposing aft end 104, a starboard side 106 and an opposing port side 108. The aircraft 100 further includes body 110 having a fuselage, a first wing 118 on the starboard side 106, and a second wing 120 on the port side 108. The fuselage includes an empennage at the aft end 104 (not separately labeled). A first engine 124 and a second engine 126 of the aircraft 100 are mounted on a top side (not shown) at the aft end 104 of the aircraft 100.

The aircraft further includes an access panel assembly 318, which may be configured in accordance with one or more exemplary aspects of the present disclosure. The access panel assembly may be positioned on the empennage, underneath one of the pair of wings, in a cargo bay of the body, or in a landing gear bay of the body. More specifically, referring still to FIG. 10, various locations where the access panel assembly may be positioned are shown, indicated by elements 318A through 318F (shown in phantom lines). The access panel assemblies 318A-318F provide remote access to the aircraft's engine lubrication systems, offering a multitude of potential benefits, including but not limited to, ease of maintenance, safety for maintenance personnel, and reduced downtime for the aircraft.

The access panel assemblies 318A, 318B are each positioned on the bottom side 114, underneath the first and second engines 124, 126. This positioning can be advantageous for maintenance operations that require close proximity to the engines while still benefiting from the safety and convenience of a remote access point.

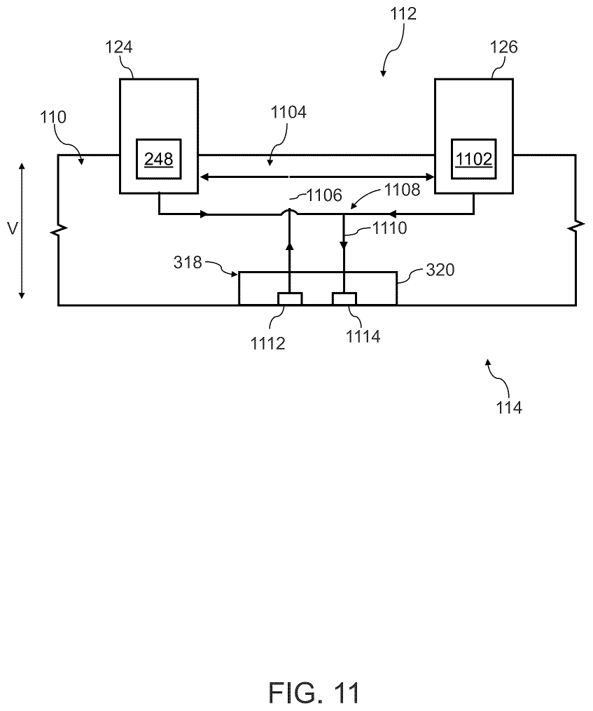

The landing gear assembly 318C is positioned on the bottom side 114, between the first and second engines 124, 126. With such a configuration, the access panel assembly 318 may facilitate maintenance operations on of the first and second engines 124, 126 (see FIG. 11, below).

Notably, the aircraft 100 includes a first landing gear bay 1002, a second landing gear bay 1004, and a third landing gear bay 1006. Each of these bays 1002, 1004, 1006 may house landing gear assemblies of the aircraft 100 during flight operations, and may be covered by one or more doors (not shown). The access panel assemblies 318D, 318E are situated within the first and second landing gear bays 1002, 1004, respectively. Such a configuration may ensure they are adequately covered during flight operations, but still accessible while the aircraft 100 is parked.

The landing gear assembly 318F is positioned on the bottom side 114, underneath the wing 118. With such a configuration, the landing gear assembly 318F may be more accessible by maintenance personnel.

Referring now to FIG. 11, a schematic view of a blended wing aircraft 100 having an access panel assembly 318 in accordance with another exemplary aspect of the present disclosure is illustrated. The aircraft 100 includes a body 110 with a top side 112 and a bottom side 114. The aircraft 100 further comprises a first engine 124 and a second engine 126, each having respective lubrication systems, 248 and 1102, that facilitate operations of the engines by providing lubrication to various engine components.

The access panel assembly 318 is operable with the lubrication system 248 of the first engine 124 and with the lubrication system 1102 of the second engine 126, and is positioned on the bottom side 114 of the aircraft 100 at a location remote from the engines. This positioning on the bottom side 114 allows for maintenance operations to be performed without the need for maintenance personnel to access the top side 112 of the aircraft where the engines are typically located.

The access panel assembly 318 is in fluid communication with a fluid delivery bus 1104 and a fluid return bus 1108. The fluid delivery bus 1104 includes a shared fluid delivery line 1106 that is operable to deliver lubrication fluid to both the first and second lubrication systems 248, 1102. Similarly, the fluid return bus 1108 includes a shared fluid return line 1110 that is operable to receive lubrication fluid from both lubrication systems 248, 1102. This shared line configuration enables the access panel assembly 318 to service multiple engine lubrication systems efficiently, reducing the complexity and number of components required for maintenance operations.

The access panel assembly 318 includes connections 1112, 1114 to the fluid delivery bus 1104 and the fluid return bus 1108, respectively. These connections facilitate the flow of lubrication fluid between the access panel assembly 318 and the lubrication systems 248, 1102, allowing maintenance personnel to perform various servicing tasks such as filling, draining, and flushing the lubrication systems from the remote location of the access panel assembly 318.

The access panel assembly 318 may otherwise be configured in a similar manner as one or more of the access panels described hereinabove.

In view of the description hereinabove, it will be appreciated that the present disclosure provides for a system for allowing various maintenance operations to be performed from a remote location, allowing for the one or more maintenance operations to be performed by maintenance personnel without traversing a top side of the blended wing aircraft. In particular, the present disclosure provides for a blended wing aircraft having an aircraft engine, the aircraft engine includes a lubrication system. The blended wing aircraft further includes an access panel assembly operable with the lubrication system of an aircraft engine, the access panel assembly positioned on or within the body at a location remote from the aircraft engine. In certain exemplary aspects, the access panel assembly may be positioned on a bottom side of the blended wing aircraft. In certain exemplary aspects, the access panel assembly may be positioned on an empennage, underneath one of the pair of wings, in a cargo bay of the body, or in a landing gear bay of the body.

The access panel assembly may allow a maintenance personnel to, e.g., check lubrication levels in a lubrication tank, drain one or more aspects of the lubrication system, fill one or more aspects of the lubrication system, flush a filter of the lubrication system, and more from the remote location despite the engine being located on a top side of the blended wing aircraft.

Further aspects are provided by the subject matter of the following clauses:

A blended wing aircraft comprising: an aircraft engine comprising a lubrication system; a body having a fuselage and a pair of wings extending outward from the fuselage; and an access panel assembly operable with the lubrication system of the aircraft engine, the access panel assembly positioned on or within the body at a location remote from the aircraft engine.

The blended wing aircraft of any preceding clause, wherein the blended wing aircraft defines a top side and a bottom side, wherein the aircraft engine is positioned on the top side and wherein the access panel assembly is positioned on the bottom side.

The blended wing aircraft of any preceding clause, wherein the access panel assembly is positioned on an empennage of the blended wing aircraft, is positioned underneath one of the pair of wings, in a cargo bay of the body, or in a landing gear bay of the body.

The blended wing aircraft of any preceding clause, wherein the access panel assembly comprises an access panel and a door, wherein the door is moveable between an open position and a closed position.

The blended wing aircraft of any preceding clause, wherein the door is moveable between the open position and the closed position without use of a tool.

The blended wing aircraft of any preceding clause, wherein the lubrication system comprises a lubrication filter, and the lubrication system comprises a supply lubrication line and a return lubrication line, wherein the lubrication filter is fluidly positioned between the supply lubrication line and the return lubrication line, and wherein the supply lubrication line and the return lubrication line each extend to the access panel assembly.

The blended wing aircraft of any preceding clause, wherein the lubrication system further comprises a first panel side valve and a first engine side valve in the supply lubrication line, and a second panel side valve and a second engine side valve in the return lubrication line, and wherein the access panel assembly includes a first valve control for the first and second panel side valves and a second valve control for the first and second engine side valves.

The blended wing aircraft of any preceding clause, wherein the lubrication system comprises a lubrication pump, and wherein the access panel assembly comprises an access panel and a power connection located on the access panel, wherein the power connection is coupled to the lubrication pump to power the lubrication pump.

The blended wing aircraft of any preceding clause, wherein the power connection is an electrical power connection.

The blended wing aircraft of any preceding clause, wherein the lubrication system comprises a lubrication tank, and wherein the access panel assembly comprises a tank supply line connection fluidly coupled to the lubrication tank.

The blended wing aircraft of any preceding clause, wherein the access panel assembly comprises a supply valve and a supply line, wherein the supply valve is in fluid communication with the supply line to control a lubrication flow therethrough, and wherein the supply line is in fluid communication with the tank supply line connection.

The blended wing aircraft of any preceding clause, wherein the access panel assembly further comprises a tank drain line connection fluidly coupled to the lubrication tank.

The blended wing aircraft of any preceding clause, wherein the access panel assembly comprises a drain valve and a tank drain line, wherein the drain valve is in fluid communication with the tank drain line to control a lubrication flow therethrough, and wherein the tank drain line is in fluid communication with the tank drain line connection.

The blended wing aircraft of any preceding clause, wherein the lubrication system comprises a lubrication tank, a sight glass for the lubrication tank, and an optical sensing assembly operable with the sight glass, and wherein the access panel assembly comprises an optical sensor interface operable with the optical sensing assembly.

The blended wing aircraft of any preceding clause, wherein the optical sensing assembly comprises a camera or a borescope.

The blended wing aircraft of any preceding clause, wherein the lubrication system comprises a lubrication tank and a lubrication level sensor, and wherein the access panel assembly comprises a sensor interface operable with the lubrication level sensor.

The blended wing aircraft of any preceding clause, wherein the aircraft engine defines a pressurized cavity, wherein the blended wing aircraft comprises a fluid pressure line extending to the pressurized cavity, and wherein the access panel assembly comprises a pressurized gas connection in fluid connection with the fluid pressure line.

The blended wing aircraft of any preceding clause, wherein the lubrication system comprises a lubrication tank and a chip detection sensor operable with the lubrication tank, and wherein the access panel assembly comprises a sensor interface operable with the chip detection sensor.

A method of operating a blended wing aircraft, the method comprising: conducting a maintenance operation of a lubrication system of an aircraft engine of the blended wing aircraft using an access panel assembly operable with the lubrication system and positioned on or within a body of the blended wing aircraft at a location remote from the aircraft engine.

The method of any preceding clause, wherein the maintenance operation is a lubrication system flush operation.

The method of any preceding clause, wherein conducting the lubrication system flush operation comprises: connecting lubrication servicing equipment to an access panel of the access panel assembly; opening, through the access panel, a first panel side valve and a first engine side valve in a supply lubrication line, and a second panel side valve and a second engine side valve in a return lubrication line; opening, using an access panel of the access panel assembly, a vent to one or more lubrication sumps of the aircraft engine; pressurizing, through the access panel, a back side of one or more lubrication seals of the aircraft engine; providing, through the access panel, clean lubrication oil to the lubrication system through a supply lubrication line; receiving, through the access panel, used lubrication oil from the lubrication system through a return lubrication line; closing, using the access panel, the first panel side valve and the second panel side valve; and disconnecting the lubrication servicing equipment from the access panel.

The method of any preceding clause, wherein the maintenance operation is a lubrication system fill operation.

The method of any preceding clause, wherein conducting the lubrication system fill operation comprises: connecting lubrication servicing equipment to an access panel of the access panel assembly; reviewing data indicative of a lubrication level in a lubrication tank of the lubrication system at an access panel of the access panel assembly; determining the lubrication level of the lubrication tank is below a lower volume threshold; opening, through the access panel, a fill valve operable with a fill line extending between the access panel and the lubrication tank and providing, through the access panel, a flow of lubrication through the fill line in response to determining the lubrication level of the lubrication tank is below the lower volume threshold; determining the lubrication level of the lubrication tank is above the lower volume threshold; closing, through the access panel, the fill valve operable with the fill line extending between the access panel and the lubrication tank in response to determining the lubrication level of the lubrication tank is above the lower volume threshold; and disconnecting the lubrication servicing equipment from the access panel.

The method of any preceding clause, wherein the maintenance operation is a lubrication system drain operation.

The method of any preceding clause, wherein conducting the lubrication system drain operation comprises: connecting lubrication servicing equipment to an access panel of the access panel assembly; opening, through the access panel, a fill valve operable with a fill line extending between the access panel and a lubrication tank and a drain valve operable with a drain line extending between the access panel and the lubrication tank; determining a lubrication level of the lubrication tank is below an empty volume threshold; closing, through the access panel, the fill valve and the drain valve in response to determining the lubrication level of the lubrication tank is below the empty volume threshold; opening, through the access panel, a vent valve in fluid communication with a vent line, the vent line in fluid communication with the drain line; and disconnecting the lubrication servicing equipment from the access panel.

The method of any preceding clause, wherein the maintenance operation is a lubrication filter backflush operation.

The method of any preceding clause, wherein conducting the lubrication filter backflush operation comprises: connecting lubrication servicing equipment to an access panel of the access panel assembly; opening, through the access panel, a first panel side valve in a supply lubrication line and a second panel side valve in a return lubrication line; closing, through the access panel, a first engine side valve in the supply lubrication line and a second engine side valve in the return lubrication line; providing, through the access panel, a flow of lubrication oil to the return lubrication line; receiving, through the access panel, the flow of lubrication oil from the supply lubrication line; closing, through the access panel, the first panel side valve in the supply lubrication line and the second panel side valve in the return lubrication line; opening, through the access panel, the first engine side valve in the supply lubrication line and the second engine side valve in the return lubrication line; and disconnecting the lubrication servicing equipment from the access panel.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A blended wing aircraft comprising:
an aircraft engine comprising a lubrication system;
a body having a fuselage and a pair of wings extending outward from the fuselage; and
an access panel assembly operable with the lubrication system of the aircraft engine, the access panel assembly positioned on or within the body at a location remote from the aircraft engine.

2. The blended wing aircraft of claim 1, wherein the blended wing aircraft defines a top side and a bottom side, wherein the aircraft engine is positioned on the top side and wherein the access panel assembly is positioned on the bottom side.

3. The blended wing aircraft of claim 1, wherein the access panel assembly is positioned on an empennage of the blended wing aircraft, is positioned underneath one of the pair of wings, in a cargo bay of the body, or in a landing gear bay of the body.

4. The blended wing aircraft of claim 1, wherein the access panel assembly comprises an access panel and a door, wherein the door is moveable between an open position and a closed position.

5. The blended wing aircraft of claim 4, wherein the door is moveable between the open position and the closed position without use of a tool.

6. The blended wing aircraft of claim 1, wherein the lubrication system comprises a lubrication filter, and the lubrication system comprises a supply lubrication line and a return lubrication line, wherein the lubrication filter is fluidly positioned between the supply lubrication line and the return lubrication line, and wherein the supply lubrication line and the return lubrication line each extend to the access panel assembly.

7. The blended wing aircraft of claim 6, wherein the lubrication system further comprises a first panel side valve and a first engine side valve in the supply lubrication line, and a second panel side valve and a second engine side valve in the return lubrication line, and wherein the access panel assembly includes a first valve control for the first and second panel side valves and a second valve control for the first and second engine side valves.

8. The blended wing aircraft of claim 1, wherein the lubrication system comprises a lubrication pump, and wherein the access panel assembly comprises an access panel and a power connection located on the access panel, wherein the power connection is coupled to the lubrication pump to power the lubrication pump.

9. The blended wing aircraft of claim 8, wherein the power connection is an electrical power connection.

10. The blended wing aircraft of claim 1, wherein the lubrication system comprises a lubrication tank, and wherein the access panel assembly comprises a tank supply line connection fluidly coupled to the lubrication tank.

11. The blended wing aircraft of claim 10, wherein the access panel assembly comprises a supply valve and a supply line, wherein the supply valve is in fluid communication with the supply line to control a lubrication flow therethrough, and wherein the supply line is in fluid communication with the tank supply line connection.

12. The blended wing aircraft of claim 10, wherein the access panel assembly further comprises a tank drain line connection fluidly coupled to the lubrication tank.

13. The blended wing aircraft of claim 1, wherein the lubrication system comprises a lubrication tank, a sight glass for the lubrication tank, and an optical sensing assembly operable with the sight glass, and wherein the access panel assembly comprises an optical sensor interface operable with the optical sensing assembly.

14. The blended wing aircraft of claim 1, wherein the lubrication system comprises a lubrication tank and a lubrication level sensor, and wherein the access panel assembly comprises a sensor interface operable with the lubrication level sensor.

15. The blended wing aircraft of claim 1, wherein the lubrication system comprises a lubrication tank and a chip detection sensor operable with the lubrication tank, and wherein the access panel assembly comprises a sensor interface operable with the chip detection sensor.

16. A method of operating a blended wing aircraft, the method comprising:
providing fluid flow to, through, or from a lubrication system of an aircraft engine of the blended wing aircraft using an access panel assembly operable with the lubrication system and positioned on or within a body of the blended wing aircraft at a location remote from the aircraft engine; and
modifying the fluid flow using the access panel.

17. The method of claim 16, wherein providing fluid flow to, through, or from the lubrication system comprises conducting a maintenance operation, the maintenance operation being a lubrication system flush operation.

18. The method of claim 16, wherein providing fluid flow to, through, or from the lubrication system comprises conducting a maintenance operation, the maintenance operation being a lubrication system fill operation.

19. The method of claim 16, wherein providing fluid flow to, through, or from the lubrication system comprises conducting a maintenance operation, the maintenance operation being a lubrication system drain operation.

20. The method of claim 16, wherein providing fluid flow to, through, or from the lubrication system comprises conducting a maintenance operation, the maintenance operation being a lubrication filter backflush operation.
